(19) United States
(12) Patent Application Publication
(10) Pub. No.: US 2004/0174268 A1
(43) Pub. Date: Sep. 9, 2004

(54) Systems, methods, and devices for manipulating a trash container door flap

(76) Inventors: Bryan Scott, Plano, TX (US); Steven Thrasher, Richardson, TX (US)

Correspondence Address: Steven Thrasher, 391 Sandhill Dr., Richardson, TX, 75080, US

(21) Appl. No.: 10/377,532

(22) Filed: Mar. 3, 2003

(51) Int. Cl. G08B 21/00

(52) U.S. Cl. 340/686.6; 318/480; 220/211; 220/260

(57) ABSTRACT

The invention teaches systems, devices and methods for manipulating a trash container member. In one embodiment, the invention automates the opening and closing of a fast-food trash cabinet door flap. The system generally includes a means for detecting motion, a means for switching a drive means on, a drive means, and a movable member.

### TECHNICAL FIELD OF THE INVENTION

The invention relates to trash containers.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art

Discussion

Trash containers, particularly of the type found in office building lobbies, are frequently comprised of a base member to hold the trash and a top member having a pivoting door flap that usually remains closed due to gravity or spring forces. Trash containers of the type commonly found in fast-food restaurants are typically comprised of an external cabinet having a top on which empty trays are stored, and a swinging door near the top of one of the sides. Due to gravity, this door hangs closed but can be pushed open with one's hand or with a tray so that garbage may be deposited into the trash bin on the inside.

When a tray having trash on it is used to push the flap open, the door flap inevitably forces the trash (which may include liquids and other food remains) off of the tray, and in many cases onto the front of the door flap, the cabinet, the floor, or the person emptying their tray. Alternatively, the door flap may be pushed open with the trash in ones hand (which is awkward), or with ones hand (which is unsanitary). Thus, existing door flaps spread surface pathogens and diseases. In addition, the door flap may be difficult to push fully open and it may be soiled from previous garbage disposal. Accordingly, there exist the need for a door flap that does not spread disease, and is not soiled with regular use.

Selected Over View of Selected Embodiments

The present invention achieves technical advantages as systems, devices, and methods that automate a trash container door flap. One system generally includes a means for detecting an object, a means for switching a drive means on, and a movable member. Thus, in one embodiment, the invention detects an object, and then in response to the object switches on a drive means, such as an electrical motor. The drive means then moves a movable member. When the drive means is an electric motor, a power transfer means, such as a teethed-gear or a lever is articulated to lift, pull, or push a trash container hanging door flap.

Accordingly, the invention eliminates the need to push the door flap open by touching it. In Addition, the system automatically holds the door flap open so that all trash can be deposited into the trash container, and not on the floor or ones self thus keeping the user of the trash can and his environment clean. Additionally, automated trash container systems promote sanitary surfaces, resulting in less disease transfer.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 provide a block diagram of one embodiment of a motion sensing automated trash container system according to the present invention;

FIG. 2 is a block diagram of a motion sensing automated trash container system core;

FIG. 3 shows a block diagram of a motion sensing automated trash container system adapted to manipulate a trash container member;

FIG. 4 illustrates a front view providing a preferred embodiment of a motion sensing automated trash container system adapted to manipulate a trash container member;

FIG. 5 is a detailed side view providing a preferred embodiment of a motion sensing automated trash container system adapted to manipulate a trash container member;

FIG. 6 shows a block diagram for one embodiment for the operation of a motion sensing automated trash container system adapted to manipulate a trash container member;

FIG. 7 illustrates an alternative embodiment of a motion sensing automated trash container system adapted to manipulate a trash container member;

FIG. 8 illustrates an alternative embodiment of a motion sensing automated trash container system adapted to manipulate a trash container member;

FIG. 9 illustrates an alternative embodiment of a motion sensing automated trash container system adapted to manipulate a trash container member;

FIG. 10 illustrates an alternative embodiment of a motion sensing automated trash container system adapted to manipulate a trash container member with a display;

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the claims section.

Discussion of the Figures

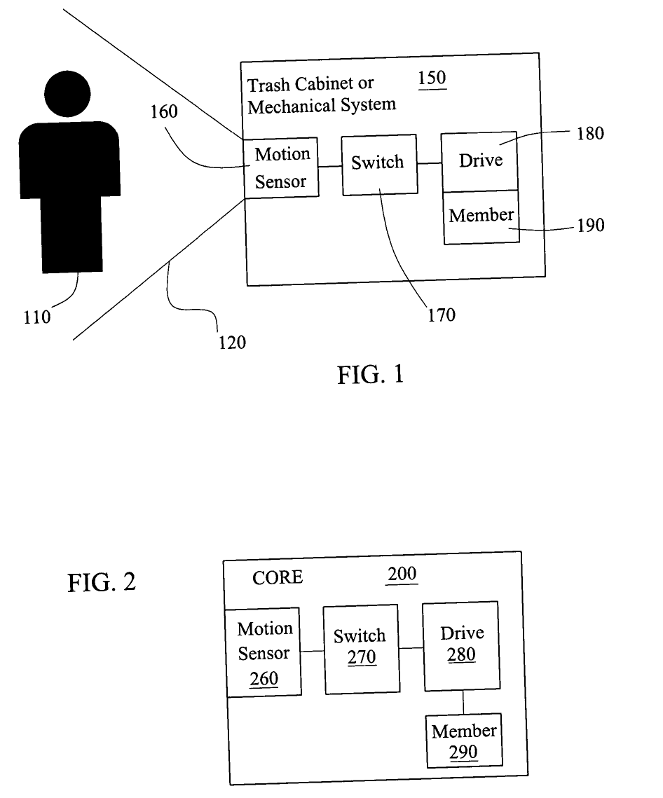

Features and advantages of the invention can be better understood by reviewing FIG. 1, which illustrates a system for automating a trash container (the system 150). The system 150 responds to an object 110 that passes within a predefined range of a motion detecting signal 120, thus providing feedback to a motion sensor 160. The object 110 may be a human, animal or inert object such as a cafeteria tray or trash.

The system 150 may be maintained in any container that is used for the disposal of trash, such as trash cabinets, trash cans, trash bins, trash buckets, or trash dumpsters, for example.

The system 150 generally includes a motion sensor 160 that is adapted to provide feedback when an object 110 passes within a motion detecting signal 120. Coupled to the motion sensor 160 is a switch 170 that converts various signals from the motion sensor 160 into control signals that articulate and otherwise control a drive 180, which is preferably embodied as a motor. The drive 180 may be a direct current (DC) or alternating current (AC) motor and is preferably a controllable motor. For example, the drive 180 maybe a multi-position motor, that is capable of positioning a drive shaft based on input signals received from the switch 170.

In alternative embodiments, the drive 180 maybe embodied as a worm screw motor, or as an electromechanical switch capable of being positioned via magnetic waves into a plurality of positions. The drive 180 then articulates a movable member 190 that is coupled to the drive 180. The movable member 190 is most often embodied as a mechanical or electrical control system adjoined to a trash container 150. For example, the member 190 maybe embodied as a baffle on a trash door flap, or as a baffle of a sliding trash door system, for example.

FIG. 2 provides a block diagram of a motion sensing automated trash container system core (the core) 200. The core 200 may be adapted to enable the automation of a trash container that is not traditionally associated with an electrical or automated mechanical control. Accordingly, in one embodiment, the core 200 may be adapted to attach to an existing trash container and accordingly manipulates (opens and closes) a trash container door flap without requiring the use of a completely customized trash container.

A motion sensor 260 is adapted to provide feedback when an object 110 passes within a motion detecting signal 220. The motion sensor 260 is capable of detecting an object via microwave radio waves, ultrasonic radio waves, a photosensor, infrared energy, or an audible sound wave, for example. Coupled to the motion sensor 260 is a switch 270 that converts feedback from the motion sensor 260, and then produces a control signal for articulating and otherwise controlling a drive 280, such as a motor as discussed above. Likewise, a movable member 290 functions and has structure similar to the movable member 190 discussed above.

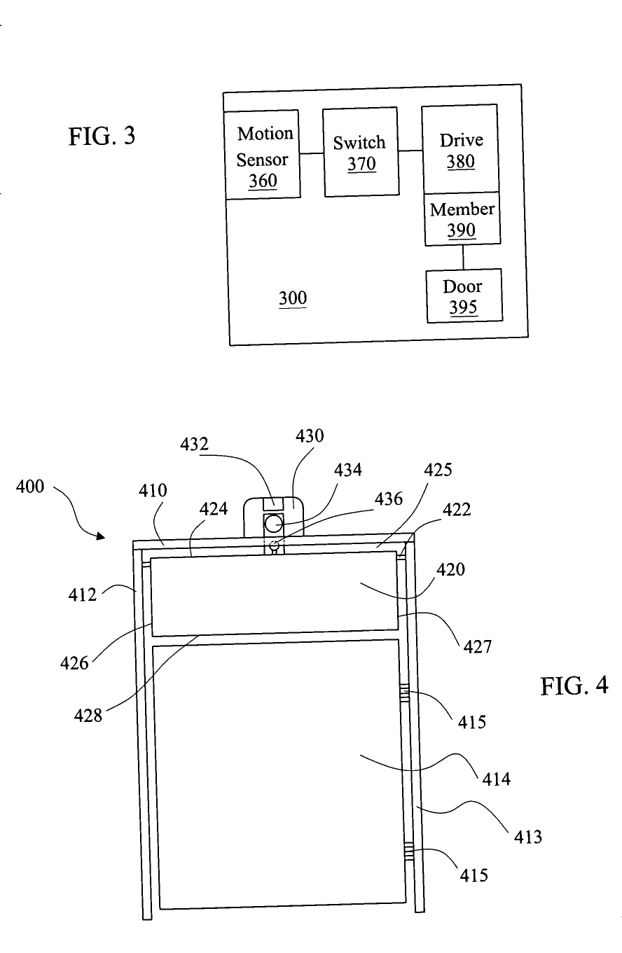

FIG. 3 shows a block diagram of an alternative motion sensing automated trash container system 300. The system 300 of FIG. 3 may be characterized as being a more specific embodiment of the system 150 of FIG. 1, with the specification that the movable member 190 of FIG. 1 is now coupled to a door flap 395 of the trash container system 300. The door flap 395 maybe characterized as any door system, such as a sliding door, or hinged door, or any movable portion of a trash container, for example.

FIG. 4 depicts a detailed front view of a preferred embodiment of a motion sensing automated trash container system for a fast-food restaurant; the trash cabinet 400 is similar to a prior art trash cabinet (or container) in that it has a top panel 410, a left side panel 412 a right side panel 413, lower door panel 414, lower door panel hinges 415, and a hanging door flap 420. The hanging door flap 420 has a pivot axis 422, top edge 424, below a top edge gap 425, left side edge 426, right side edge 427, and bottom edge 428.

The invention illustrated in FIG. 4 comprises a motion sensor 432, a motor 434, and a worm screw gear 436. The invention is preferably centrally mounted on the top panel 410 along the front edge of the trash cabinet 400 between the left side panel 412 and the right side panel 413. In other embodiments the invention 430 can be mounted above the pivot axis 422 on the left side edge 426 or right side edge 427 of the trash cabinet 400. The invention, or components of the invention, can be mounted to the trash cabinet 400, or any component of the trash cabinet 400, with screws, nails, clips, brackets, or other mounting devices apparent to those skilled in the art.

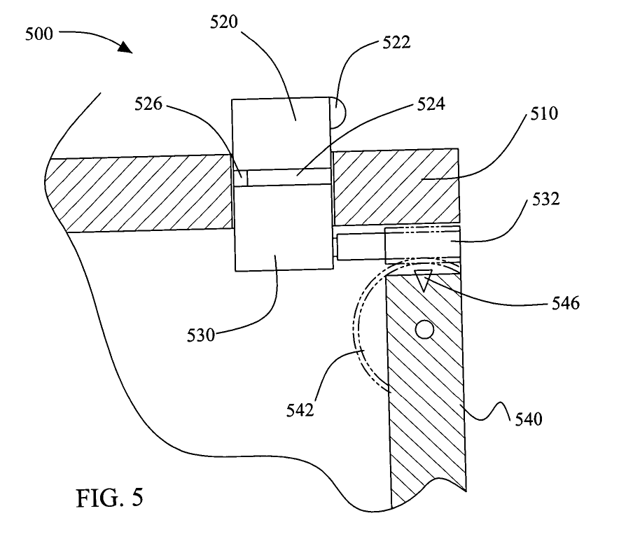

FIG. 5 depicts a side view of a preferred embodiment of a trash container automation system 500. From FIG. 5 one can see that the trash automation system has a motion sensor 520, with a lens 522 on the outer side of the motion sensor 520 facing toward the front of the trash cabinet, securely mounted to the cabinet top 510. The motion sensor 520 is coupled to an electric switch 524, wherein the motion sensor 520 and the electric switch 524 are embodied as a single component that produces a control signal for controlling an electric motor 530 that drives a gearbox 532. The gearbox 532 is coupled between a drive of the electronic motor and a movable member 540 of a trash container. The gearbox 532 thereby articulates a gear 542 that is securely fastened to the hanging door flap 540 by a fastening member 546, such as a screw, nail, clip, or bracket, for example, resulting in the opening and closing of the hanging door flap 540. Alternatively, a predetermined amount of time can pass, and the trash container member can preferably close, triggered by a timing device 526 coupled to the electric switch 524.

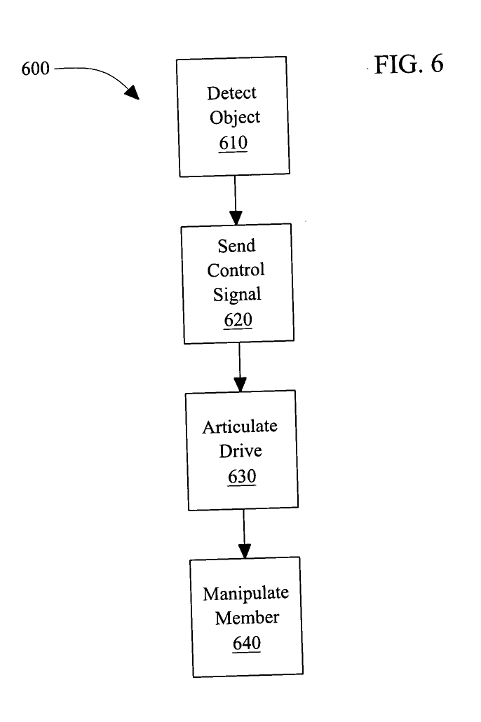

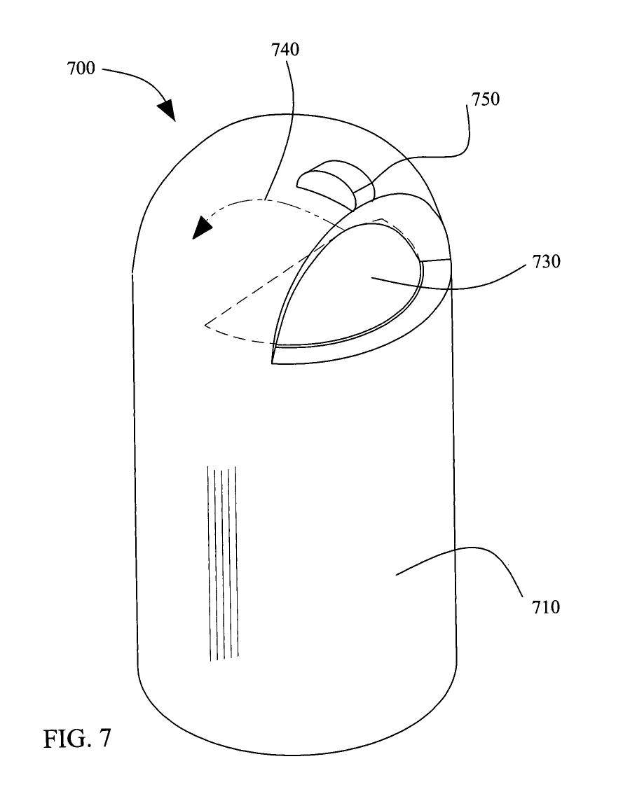

FIG. 6 provides a preferred method for operation of an automated trash container 400. As illustrated, an object 610, is placed in proximity to the trash container, causing the motion sensor 620 to detect the object 610 and send a control signal 620 in response to the object 610. The control signal 620 articulates a drive 630 from a first position to a second position manipulating a movable member 640 to a plurality of positions, preferably open. Similarly, the motion sensor 610 detects when an object 610 separates from the trash container member (or a predetermined amount of time) to move to any plurality of a plurality of positions.

FIG. 7 provides perspective view of an alternative embodiment of automated trash container system 700. From FIG. 7 one can see the container base 710 for holding disposed trash, the container top 720, for enclosing disposed trash, and a trash container sliding door 730 and container sliding door path 740. The invention 750 is mounted centrally on the front face of the container top 720 resulting in the opening and closing of the trash container sliding door 730.

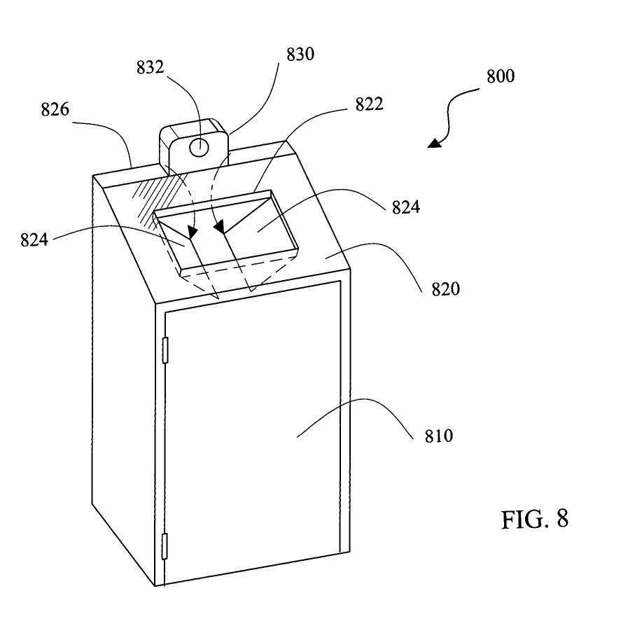

FIG. 8 provides a perspective view for an alternative embodiment of an automated trash container system 800. From FIG. 8 one can see the open top container base 810 for holding disposed trash, the container top 820, the container top opening 822, the open top container trash flaps 824 (that open inward), and the rear edge 826. The trash container automation system 830 is mounted centrally near the rear edge 826 of the container top 820 capable of sensing an object approaching the invention 800 resulting in the opening and closing of the trash container flaps 824.

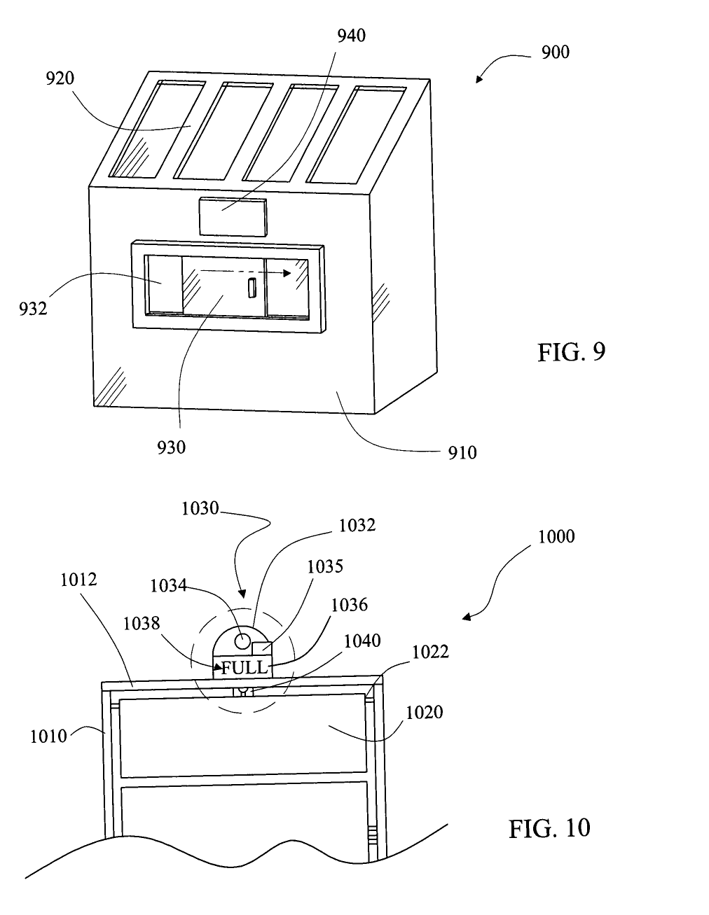

FIG. 9 provides a perspective view for an alternative embodiment of an automated trash container system 900. From FIG. 9 one can see the trash dumpster 910 for holding disposed trash, the trash dumpster top 920, the trash dumpster sliding door 930, and the trash dumpster sliding door opening 932 for discarding trash. The trash container automation system 940 is mounted above the trash dumpster sliding door 930 capable of sensing an object approaching the invention 900 resulting in the opening and closing of the trash dumpster sliding door 930.

FIG. 10 provides a front view for an alternative embodiment of an automated trash container system 1000 which includes a display 1034. From FIG. 10 one can see the automated trash container assembly 1000 includes a right side panel 1010, a top panel 1012, a hanging door flap 1020, and a door pivot 1022, as shown in FIG. 4. The invention 1030 includes a motion sensor 1032, an electric switch 1035, a drive 1040, and a display 1036. The motion sensor 1032 is capable of detecting an object, and also capable of generating an electric signal. The electric switch 1035 is capable of passing a control signal to an electric motor. The switch is also capable of passing a message signal to a display. The electric motor has a drive 1040 that is adjoined to a movable member of the trash container assembly 1000.

The display 1036 is capable of displaying a visual message 1038 or projecting an audible message to a user. The display can be any type of display such as a liquid crystal display, a character display, or a numeric display, for example. The visual message 1038, can be any type of message such as a lighted placard, a picture, is a colored light, or is alphanumeric, for example. The audible message 1039 can be any type of sound such as a pre-recorded human voice, song, or sound effect The display 1036 can be adjoined of the trash automation system assembly or embodied as a separate component. The display 1036 can be powered directly from the motion sensor 1032, switch 1035, or separately from an alternating current (AC) or direct current (DC), for example. The display 1036 can receive a control signal from the switch 1035, or a source other than the switch, to display a message 1038, for example.

Accordingly, the invention can be characterized as a motion sensing automated trash container system. The motion sensing automated trash container system typically includes a motion sensor that is capable of detecting an object, generating an electrical signal, and an electrical switch coupled to the motion sensor and to an electric motor. The switch is capable of passing sufficient power to drive the electric motor, and the electric motor has a drive coupled to a movable trash container or trash container member, such as a hanging door flap, or sliding door flap, for example, for opening and closing a trash container.

Often, the motion sensor and the electric switch are embodied as a single component, such as an integrated circuit (IC), or a single printed circuit board having components thereon, or a customized electronic chip, for example. This will often depend of the type of motion sensing signal feedback the motion sensor is to receive. In one embodiment, the motion sensing signal the motion sensor is to receive is infrared energy, however, it should be understood that light, microwave radio energy, or ultrasonic sound waves could also be used and may be preferred in environment whereby an active system is required.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. An object sensing automated trash container system comprising:
an object sensor that is enabled to detect an object, and enabled to generate an electronic signal; and
an electric switch coupled to the motion sensor and to an electric motor,
the electric switch capable of passing a control signal to the electric motor,
the electric motor having a drive, the drive being adjoined to a movable member.

2. The motion sensing automated trash container system of claim 1 wherein the motion sensor and the electric switch are embodied as a single integrated component.

3. The motion sensing automated trash container system of claim 1 wherein the motion sensor is enabled to detect an object via ultrasonic radio waves.

4. The motion sensing automated trash container system of claim 1 wherein the motion sensor is enabled to detect an object via a photosensor.

5. The motion sensing automated trash container system of claim 1 wherein the electric motor operates using an alternating current.

6. The motion sensing automated trash container system of claim 1 further comprising a gearbox coupled between the drive of the electronic motor and the movable member.

7. A method of manipulating a trash container system movable member, comprising:
detecting an object; and
sending a control signal to a drive in response to the detecting the object, the control signal controlling the articulation of the drive from a first position to a second position, wherein the drive articulates a movable member.

8. An object sensing automated trash container comprising:
a motion sensor that is enabled to detect an object, and also enabled to generate an electronic signal;
an electric switch coupled between the motion sensor and an electric motor;
the electric switch also enabled to pass a control signal to an electric motor;
the electric switch also enabled to pass a message signal to a display mounted on the exterior portion of the trash container;
the display enabled to generating a message; and
the electric motor having a drive, the drive being adjoined to a movable member.

9. The object sensing automated trash container of claim 8 wherein the object sensor and the electric switch are embodied as a single integrated component.

10. The object sensing automated trash container of claim 8 further comprising a gearbox coupled between the drive of the electronic motor and the movable member, the gearbox for increasing a torque produced by the electric motor.

11. The object sensing automated trash container of claim 8 further comprising a timing device coupled to the electric switch.

12. The object sensing automated trash container of claim 8 wherein the display is a liquid crystal display.

13. The object sensing automated trash container of claim 8 wherein the message is a lighted placard.

14. The object sensing automated trash container of claim 8 wherein the message is a picture.

15. The object sensing automated trash container of claim 8 wherein the message is a colored light.

16. The object sensing automated trash container of claim 8 wherein the message comprises alphanumeric characters.

17. The object sensing automated trash container of claim 8 wherein the message is an audible sound.
